(19) United States
(12) Patent Application Publication
(10) Pub. No.: US 2026/0030305 A1
(43) Pub. Date: Jan. 29, 2026

(54) CONTENT OPTIMIZATION METHOD AND SYSTEM FOR ENHANCING SEARCH ENGINE OPTIMIZATION (SEO) OF A WEBSITE

(71) Applicant: Originality.AI Inc., Collingwood (CA)

(72) Inventors: Jonathan Gillham, Collingwood (CA); Conor Watt, Collingwood (CA); Liam McNally, Collingwood (CA); Joshua Moshood, Collingwood (CA); Janay Ma, Collingwood (CA); Trinh Tran, Collingwood (CA)

(73) Assignee: Originality.AI Inc., Collingwood, ON (CA)

(21) Appl. No.: 19/270,161

(22) Filed: Jul. 15, 2025

Related U.S. Application Data
(60) Provisional application No. 63/674,511, filed on Jul. 23, 2024.

(51) Int. Cl. G06F 16/9535; G06F 16/2457

(52) U.S. Cl. CPC G06F 16/9535; G06F 16/24578

(57) ABSTRACT

The present disclosure provides a search engine optimization (SEO) system comprising a remote server. The remote server comprises a memory with a set of executable routines and a search engine database with multiple fields of applications, each associated with multiple URLs indexed with a user engagement matrix, written data, and a search engine ranking. A processor acquires a web link from a computing device, extracts textual content, analyzes relevancy, and retrieves relevant URLs. The processor evaluates a thematic score, a readability score, and an emotional tone data using NLP techniques, analyzes written data of each URL to determine a topic weight, a legibility weight, and a sentiment tone data, develops a machine learning model, applies the model to recommend content alterations, and renders the alterations at the computing device.

### CROSS REFERENCE TO RELATED APPLICATION

This application claims the benefit under 35 U.S.C. § 119(e) of U.S. Provisional Application No. 63/674,511 entitled “CONTENT OPTIMIZATION METHOD AND SYSTEM FOR ENHANCING SEARCH ENGINE OPTIMIZATION (SEO) OF A WEBSITE” filed Jul. 23, 2024, which is incorporated herein by reference.

### TECHNICAL FIELD

The present disclosure generally relates to search engine optimization (SEO) systems. Further, the present disclosure particularly relates to a system to enhance search engine optimization of a website.

### BACKGROUND

Search engine optimization (SEO) involves enhancing a website to improve the ranking on search engine results pages (SERPs) to increase the visibility of the website and attract more organic traffic from search engines. SEO techniques include keyword optimization, content creation, backlinking, and technical improvements. The effectiveness of SEO practices is measured by how well a website ranks for relevant search queries.

One of the significant challenges in SEO is identifying the specific changes required to optimize a piece of content for higher search engine rankings. Conventional systems rely on general guidelines and best practices, but they often lack the precision needed to address the unique characteristics of individual websites and content. Such limitations result in suboptimal SEO performance and missed opportunities for ranking improvements.

Various state-of-the-art systems and techniques are known to assist in the SEO process. One such technique involves using keyword density analysis, which evaluates the frequency and distribution of keywords within the content. While said method helps in making sure that content is relevant to specific search queries, said method does not consider other essential factors such as readability and emotional tone, which are important for user engagement and satisfaction.

Another commonly used technique is backlink analysis, where the quality and quantity of inbound links to a website are evaluated. Said technique helps in determining the authority and relevance of website in the field of application. However, backlink analysis alone does not provide insights into the content quality or user engagement metrics, which are equally important for SEO success.

A further technique involves content management systems (CMS) that offer built-in SEO tools and plugins. Such tools enable users to optimize their content by providing suggestions for meta tags, headings, and keyword placement. While CMS tools are useful for on-page SEO optimization, they often lack the ability to provide personalized recommendations based on real-time data and analysis of user engagement metrics.

Moreover, machine learning and natural language processing (NLP) techniques have been employed to enhance SEO by analyzing large datasets and identifying patterns. Such techniques can evaluate thematic relevance, readability, and emotional tone of the content. Despite their potential, current systems utilizing machine learning and NLP are often limited by the quality and scope of the training data, leading to inaccurate recommendations and subpar SEO outcomes.

In light of the above discussion, there exists an urgent need for solutions that overcome the problems associated with conventional systems and/or techniques for identifying specific changes to optimize content for higher search engine rankings.

### SUMMARY

The present disclosure provides a search engine optimization (SEO) system comprising a remote server. Said remote server comprises a memory and a processor. The memory comprises a set of executable routines and a search engine database comprising multiple fields of applications. Each field of application is associated with multiple uniform resource locators (URLs). Each URL is indexed individually with a user engagement matrix, written data, and a search engine ranking. The processor acquires a web link from a computing device and access the acquired web link to extract textual content. The processor further analyzes the extracted textual content to determine the relevancy of the field of application and acquire each URL from the search engine database based on the determined relevant field of application. The processor evaluates the extracted textual content to determine a thematic score, a readability score, and an emotional tone data by applying a natural language processing (NLP) technique. The processor also analyzes the written data associated with each acquired URL to determine a topic weight, a legibility weight, and a sentiment tone data by applying the NLP technique. Additionally, the processor develops a machine learning model utilizing the search engine database, the determined topic weight, the determined legibility weight, and the determined sentiment tone data of each URL. The processor applies the developed machine learning model to the determined thematic score, readability score, and emotional tone data of the extracted textual content to recommend content alterations required to enhance the search engine optimization of the web link. The processor renders the recommended content alterations at the computing device.

In an embodiment, the recommended content alterations are based on multiple SEO factors selected from a keyword density, the meta tags, a content structure, and the user engagement elements. Such factors enable optimization of the textual content to enhance visibility and ranking on search engine results pages. The system evaluates each factor, applying appropriate weightage to optimize the web link effectively.

In an embodiment, the server enables integration with a content management system (CMS) and SEO platforms. Such integration facilitates automated content optimization workflows, allowing seamless updates and modifications to the textual content based on the recommended alterations. The integration streamlines the process of content optimization, reducing manual efforts and assuring consistent updates to maintain the relevancy and effectiveness of the content.

In an embodiment, an application program interface (API) is utilized to allow the user to implement the recommended content alterations into the textual content of the web link and the optimization processes. Such an API provides a user-friendly interface for content creators to apply the recommended changes. The API enhances the usability of the system, making the process of content optimization more accessible and efficient for users with varying levels of technical expertise.

In an embodiment, the server automates a process of competitor analysis and benchmarking by using an artificial intelligence (AI) technique. Such automation enables continuous monitoring of competitor content strategies, providing insights into successful tactics and areas for improvement. The AI-driven analysis identifies trends and patterns in competitor content, allowing users to adjust their strategies accordingly.

In an embodiment, the server generates the detailed SEO reports comprising a keyword performance, a content analysis, the backlink profiles, and an overall SEO score. Such reports provide insights into the effectiveness of the SEO strategies employed. The keyword performance analysis highlights the success of targeted keywords, while the content analysis evaluates the quality and relevancy of the textual content. The backlink profiles offer insights into the external links pointing to the web link, contributing to the authority and ranking. The overall SEO score provides a quantitative measure of the optimization success, enabling users to track progress and identify areas for further improvement.

In an embodiment, the server utilizes a sentiment analysis technique to gauge user sentiment from one or more social media and other online platforms to generate mood data. Said server further incorporates the generated mood data into the SEO recommendations. Such incorporation makes sure that the content meets technical SEO criteria and resonates emotionally with the target audience. The sentiment analysis provides a deeper understanding of audience preferences and reactions, allowing content creators to tailor their strategies to better align with audience sentiments.

In an embodiment, the search engine optimization (SEO) system enhances the relevancy, readability, and emotional appeal of web content. The system applies advanced natural language processing (NLP) techniques and machine learning models to evaluate and optimize the textual content of web link. The integration of server with content management systems (CMS) and SEO platforms enables streamlined workflows and efficient content optimization processes. Additionally, the automation of competitor analysis and benchmarking through artificial intelligence (AI) techniques provides valuable insights for maintaining competitive content strategies. The detailed SEO reports generated by the system offer evaluations of a keyword performance, a content quality, the backlink profiles, and the overall SEO scores.

In an embodiment, the SEO system evaluates textual content extracted from web link to determine the thematic score, the readability score, and the emotional tone data. The system applies NLP technique to analyze written data associated with URLs in the search engine database, the determining topic weight, the legibility weight, and the sentiment tone data. The development of machine learning models utilizing said parameters enables precise recommendations for content alterations aimed at enhancing SEO. The integration with CMS and SEO platforms facilitates automated workflows, while the use of API allows users to implement recommended changes seamlessly. The automated competitor analysis and benchmarking provide continuous insights into competitor content strategies, assuring the content of user remains competitive. The detailed SEO reports generated by the system offer insights into the effectiveness of the SEO strategies employed, including the keyword performance, the content analysis, the backlink profiles, and the overall SEO scores.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein.

Embodiments of the present disclosure will now be described, by way of example only, with reference to the following diagrams.

FIG. 1 illustrates a system to enhance search engine optimization (SEO) of a website, in accordance with the embodiments of the present disclosure;

FIG. 2 illustrates a tabular arrangement of an exemplary search engine database in accordance with the embodiments of the present disclosure; and

FIG. 3 illustrates a sequence diagram of system to enhance search engine optimization (SEO) of a website in accordance with the embodiments of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

As used herein, the term “system” is used to refer to an integrated assembly enhances search engine optimization (SEO) of a website. The system comprises various interconnected components that work collectively to improve the visibility and ranking of the website on search engine results pages (SERPs). The system may include both hardware (e.g., servers, memory units, processors, and computing devices, each playing a specific role in the SEO enhancement process) and software elements.

As used herein, the term “server” is used to refer to a computer or a network of computers, which can provide various services and resources to other computers within the system. The server hosts a memory and a processor that enables the operations of the system. The server is responsible for storing and processing large volumes of data, including URLs, user engagement matrices, written data, and search engine rankings. The “server” as used herein is responsible for data acquisition, content crawling, analysis, and rendering of SEO recommendations.

As used herein, the term “memory” is used to refer to a storage component within the server that comprises a set of executable routines and a search engine database. The memory stores data related to multiple fields of application, wherein each field of application is associated with multiple/numerous URLs. The memory indexes each URL with relevant information such as user engagement matrices, written data, and search engine rankings.

As used herein, the term “processor” is used to refer to the central processing unit within the server responsible for executing the stored routines and managing the operations of system. The processor acquires web link from computing devices, crawls websites to extract textual content, and analyses extracted textual content to determine relevant field of application. The “processor” also evaluates the content using natural language processing techniques to determine thematic relevance, readability, and emotional tone.

As used herein, the term “computing device” is used to refer to any electronic device capable of connecting to the server and interacting with the system. The computing device could be a personal computer, smartphone, tablet, or any other digital device that allows a user to input URLs, receive SEO recommendations, and implement suggested content alterations. The “computing device” as used herein displays the recommended content alterations and facilitates real-time interaction with the server for enhanced SEO.

As used herein, the term “uniform resource locator” or “URL” or “web link” is used to refer to the address of a specific webpage or file on the internet. The URL allows the system to identify and access the content of the website that needs to be optimized for search engines.

As used herein, the term “textual content” as used throughout the present disclosure relates to the written material extracted from a web link by a remote server. Said textual content comprises various forms of written data, including but not limited to articles, blog posts, product descriptions, reviews, and other relevant text found on a webpage. The textual content is analyzed by the processor to determine the relevancy of the field of application. Additionally, the textual content is evaluated to ascertain a thematic score, a readability score, and an emotional tone data by applying natural language processing (NLP) techniques. Such analysis further facilitates the determination of the suitability and effectiveness of content in relation to SEO criteria.

As used herein, the term “written data” is used to refer to the written material available on a website that is subject to SEO analysis and optimization. The written data includes articles, blog posts, product descriptions, and any other form of written communication intended for users. The “written data” as used herein includes all the textual data extracted from the website by the system for evaluation and recommendation purposes.

As used herein, the term “search engine ranking” is used to refer to the position of a website on search engine results pages (SERPs) for specific search queries. The search engine ranking is influenced by various factors, including keyword relevance, user engagement, and content quality. The “search engine ranking” as used herein comprises the metrics and data used by the system to determine the effectiveness of the SEO strategies implemented on the website.

As used herein, the term “user engagement matrix” is used to refer to a set of metrics that measure how users interact with the website. The metrics comprise data such as page views, time spent on the site, bounce rate, and click-through rate. The “user engagement matrix” as used herein includes all the engagement data indexed by the system to evaluate the performance and relevance of the content of website.

As used herein, the term “natural language processing technique” or “NLP technique” is used to refer to a set of computational methods used to analyze and understand human language. NLP techniques enable the system to evaluate the thematic relevance, readability, and emotional tone of the text. The “natural language processing (NLP) technique” as used herein includes all the methods and protocols used by the system to process and analyze the textual data.

As used herein, the term “machine learning model” is used to refer to a computational model developed using algorithms that allow the system to learn from data and make predictions or recommendations. The machine learning model is trained on the search engine database and various metrics to provide SEO recommendations. The “machine learning model” as used herein includes all the learning techniques and data analysis methods used by the system to enhance the SEO of the website.

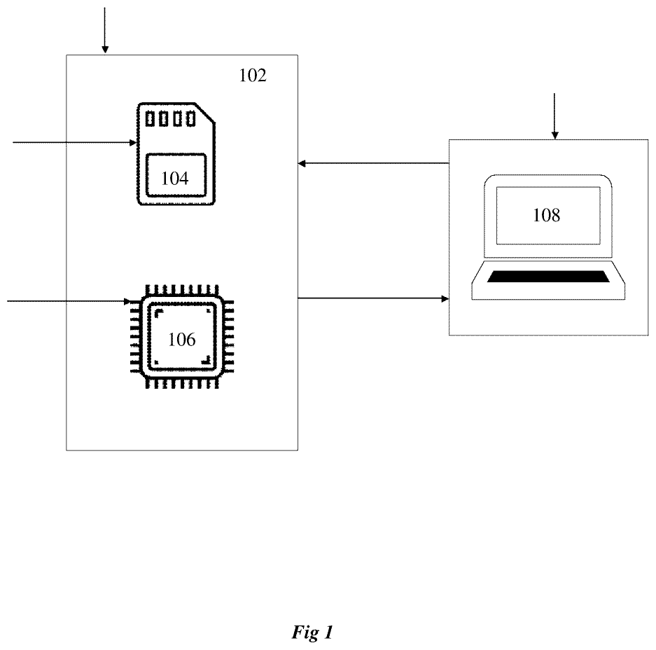

FIG. 1 illustrates system 100 to enhance search engine optimization (SEO) of a website, in accordance with the embodiments of the present disclosure. A remote server 102 is disclosed comprising a memory 104 and a processor 106 to enhance search engine optimization (SEO) of a website. A user can access the website on a client or user computer 108. Memory 104 comprises a set of executable routines and a search engine database. The search engine database encompasses multiple fields of application (e.g., social media, corporate websites, new portals, forums, job boards, eCommerce, educational, governmental, community forum, video streaming platform, review portal etc.). Each field of application corresponds to the multiple uniform resource locators (URLs).

In an embodiment, the memory 104 stores said executable routines and the search engine database. The search engine database comprises multiple fields of application. Each field of application within the search engine database is associated with a plurality of URLs. Each URL is further indexed individually with several parameters. Aforesaid parameters include a user engagement matrix, written data, and a search engine ranking.

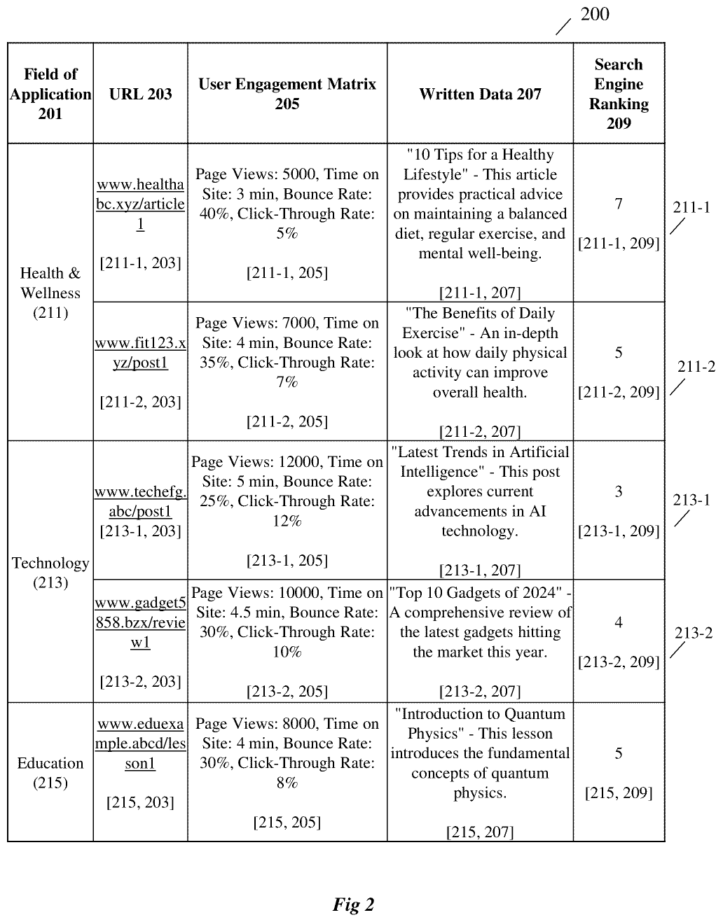

FIG. 2 illustrates a tabular arrangement 200 of an exemplary search engine database in accordance with the embodiments of the present disclosure. The tabular arrangement 200 organizes information including fields of invention (column 201), URL (column 203), the user engagement matrix (column 205), the written data (column 207) and the search engine ranking (column 209). As shown in FIG. 2, each row of tabular arrangement 200 corresponds to one field of invention. For example, row 211 corresponds to health and wellness; row 213 corresponds to technology; and row 215 corresponds to education. Furthermore, in some embodiments, a row comprises a plurality of sub-rows. For example, row 211 comprises sub-rows 211-1 and 211-2; and row 213 comprises sub-rows 213-1 and 213-2. Said structured data organization enables efficient retrieval and analysis of website content for SEO purposes. Each of these sub-rows corresponds to one of the websites related to the field of invention corresponding to the row. The URL of the website is provided in the cell corresponding to column 203. For example, sub-row 211-1 corresponds to a healthcare website. Cell [211-1, 203] contains the URL “www.healthabc.xyz/article1” for the website corresponding to sub-row 211-1. The user engagement matrix cell for each URL comprises data reflecting how users interact with the associated website. For example, cell [211-1, 205] corresponds to the user engagement matrix for the website corresponding to sub-row 211-1. Metrics such as page views, time spent on the site, bounce rate, and click-through rate are included in the cell corresponding to the user engagement matrix.

In an embodiment, the written data associated with each URL includes all written material present on the website. Articles, blog posts, product descriptions, and other forms of written communication are encompassed. For example, in FIG. 2 cell [211-1, 207] comprises the written data associated with the website and the URL in cell [211-1, 203].

In an embodiment, the search engine ranking for each URL indicates the position of the website in search engine results pages (SERPs). Various factors influencing the search engine ranking, such as a keyword relevance, a content quality, and a user engagement, are considered. For example, in FIG. 2 cell [211-1, 209] comprises the written data associated with the website associated with sub-row 211-1, and the URL in cell [211-1, 203]. The remote server 102 utilizes the ranking information to guide the SEO enhancement process. Each of the fields of application within the search engine database corresponds to distinct areas relevant to SEO. Said fields of application categorize URLs based on the nature of the content and target audience.

In an embodiment, the set of executable routines, (stored in memory 104) when executed perform several key operations. Said set of executable routines enable the remote server 102 to acquire a web link from a computing device 108, crawl a website associated with the acquired web link to extract textual content, and analyze the extracted textual content to determine a relevancy of the field of application. By processing the extracted textual content, remote server 102 can evaluate a thematic score, a readability score, and an emotional tone data. The search engine database, along with the set of executable routines, empowers remote server 102 to deliver tailored SEO recommendations based on the analysis of the user engagement matrix, the written data, and the search engine ranking.

In an embodiment, remote server 102 allows for the continuous updating and indexing of URLs. As new data is acquired, the search engine database is dynamically updated to reflect the latest user engagement metrics, the written data, and the search engine rankings. The dynamic updating process maintains the accuracy and relevance of the SEO recommendations provided by remote server 102. Processor 106 performs various functions to enhance the search engine optimization (SEO) of the website. Processor 106 executes a series of operations to analyze and optimize website content.

In an embodiment, processor 106 acquires web link of the website from the computing device 108. The web link serves as the address of the website that requires optimization. Upon receiving the web link, the processor 106 initiates crawling operation to extract the textual content from the website. Crawling involves systematically scanning the website to gather all available text-based information.

In an embodiment, subsequent to the extraction, processor 106 analyzes the extracted textual content to determine the relevant field of application. Said analysis involves identifying the primary subject matter and categorizing the content accordingly. By determining the relevant field of application, the processor 106 can contextualize the textual content and enhance the relevance for specific search queries. The processor 106 further acquires each URL from the search engine database based on the determined relevant field of application. The search engine database, stored in memory 104, contains multiple fields of application, each corresponding to various URLs.

In an embodiment, processor 106 evaluates the extracted textual content to determine the thematic score, the readability score, and the emotional tone data. The evaluation is conducted by applying a natural language processing (NLP) technique. The thematic score assesses how well the content aligns with the identified relevant field of application. The readability score measures the case with which the content can be read and understood by the target audience. The emotional tone data analyzes the sentiment conveyed by the extracted textual content, identifying whether the tone is positive, negative, or neutral.

In an embodiment, processor 106 also analyzes the written data associated with each of the acquired URL (from the memory 104) to determine a topic weight, a legibility weight, and sentiment tone data. The analysis is performed by applying an NLP technique similar to the one used for the extracted textual content. The topic weight, the legibility weight, and the sentiment tone data of the acquired URLs provide benchmarks against which the content of website can be compared.

Following the analysis, processor 106 develops a machine learning model by utilizing the search engine database, the determined topic weight, the determined legibility weight, and the determined sentiment tone data of each acquired URL. The machine learning model is trained to identify patterns and correlations within the data, enabling processor 106 to generate accurate and effective SEO recommendations.

In an embodiment, the developed machine learning model is then applied to the determined thematic score, the determined readability score, and the determined emotional tone data of the extracted textual content of the website (accessed by visiting the acquired web link). By applying the developed machine learning model, processor 106 can identify specific content alterations required to enhance the SEO of the website. The alterations improve the search engine ranking of website by making the content more relevant, readable, and engaging.

In an embodiment, processor 106 renders the recommended content alterations at the computing device 108. The recommendations are displayed to the user, providing clear and actionable guidance on how to modify the content to achieve better SEO results. The user can implement said recommendations to optimize the content of website, thereby improving the visibility and ranking on search engine results pages (SERPs).

In an exemplary aspect, Alice, the owner of an e-commerce website, decides to use the system 100 to enhance the search engine optimization (SEO) of said e-commerce website. Alice begins by accessing system 100 through computing device 108, where Alice inputs the web link of the e-commerce website. The processor 106 within remote server 102 acquires the web link and initiates a crawling operation to extract all textual content from the website. The textual content includes product descriptions, category pages, blog posts, and customer reviews, forming the basis for further analysis and optimization.

Once the textual content is extracted, processor 106 analyzes the extracted textual content to determine the relevant field of application of website. For the e-commerce website of Alice, the primary relevant field of application include fashion, electronics, and home decor. Said categorization helps in contextualizing the content for specific search queries relevant to said fields of application. Based on the determined relevant field of application, processor 106 acquires relevant URLs from the search engine database stored in memory 104. Said acquired URLs serve as benchmarks for further analysis and comparison, each associated with a user engagement matrix, a written data, and a search engine ranking data.

In a further embodiment, processor 106 evaluates the extracted textual content from website of Alice to determine a thematic score, a readability score, and an emotional tone data. Said evaluation is conducted by applying NLP technique. For instance, the thematic score for a fashion-related product description might be 85 out of 100, indicating strong alignment with the fashion category. The readability score for the same content might be 70, suggesting that the content is reasonably easy to read but could be simplified for a broader audience. The emotional tone data might include an analysis showing that the content conveys a friendly and professional tone, with user feedback indicating high satisfaction and engagement times suggesting good user interaction.

In another embodiment, processor 106 also analyzes the written data associated with each of the acquired URLs (which are in same field of application i.e., eCommerce). Aforesaid analysis involves determining a topic weight, a legibility weight, and a sentiment tone data using NLP techniques. For example, URL in the fashion category might have a topic weight score of 90 and a legibility weight of 80. The sentiment tone data for the URL might show a trustworthy and engaging tone, with positive user feedback and low bounce rates. Said scores (topic weight score and legibility weight) and the sentiment tone data from the URLs provide benchmarks against which the content of Alice can be compared.

Following the analysis, processor 106 develops machine learning model utilizing the search engine database, along with the determined, topic weight, legibility weight, and sentiment tone data of each URL. The machine learning model is trained to identify patterns and correlations within the data, enabling the system 100 to generate accurate SEO recommendations. For instance, the machine learning model might recognize that content with a readability score above 75 and a friendly yet professional tone tends to rank higher in search engine results.

In a preceding embodiment, the developed machine learning model is then applied to the evaluated scores (thematic score and readability score) and emotional tone data of the website content of Alice. By applying the developed machine learning model, processor 106 can identify specific content alterations required to enhance the SEO of the website. For example, the model might recommend increasing the readability score of a product description from 70 to 80 by simplifying the language and maintaining a professional tone to attract more engagement. Processor 106 renders the recommended content alterations on computing device 108. Alice receives clear and actionable guidance on how to modify the website content to achieve better SEO results. The recommendations are presented in a user-friendly format, allowing Alice to easily implement the suggested changes. For example, the system might suggest changing “The dress is quite nice and comfortable” to “The dress is exceptionally comfortable and stylish” to improve both readability and engagement.

In an embodiment, the recommended content alterations may be based on multiple SEO factors which are selected from a keyword density, the meta tags, a content structure, and user the engagement elements. The processor 106 evaluates the textual content to identify the optimal keyword density that enhances relevance without overstuffing. Meta tags are analyzed and recommended so that they accurately reflect the content and improve search engine visibility. The content structure is assessed for logical flow and readability, with suggestions to improve headings, subheadings, and paragraph organization. User engagement elements, such as interactive features and multimedia content, are recommended to increase visitor interaction and retention. By addressing said SEO factors, system 100 provides recommendations that improve the overall quality and search engine ranking of the website content.

In an embodiment, the remote server 102 may enable integration with content management systems (CMS) and SEO platforms to facilitate automated content optimization workflows. The integration allows system 100 to seamlessly interact with popular CMS platforms such as WordPress®, Joomla®, and Drupal®, as well as SEO tools like Yoast®, SEMrush®, and Moz®. The integration streamlines the process of applying recommended content alterations by automating tasks such as updating meta tags, restructuring content, and adjusting keyword usage. The automated workflow reduces the time and effort required by website owners and SEO professionals to implement the recommendations.

In an embodiment, an application program interface (API) may be utilized to allow the user to directly implement the recommended content alterations into the content of the website and optimization processes. The API provides a standardized method for remote server 102 to communicate with the CMS of website and other related platforms. Through the API, the recommended changes are automatically pushed to the website, eliminating the need for manual updates. The direct implementation enables the SEO recommendations to be applied accurately and consistently. Users can customize the API settings to control the extent and timing of the changes, giving them flexibility and control over the optimization process. The API also facilitates real-time monitoring and feedback, allowing users to see the immediate impact of the changes on the SEO performance of website.

In an embodiment, remote server 102 may automate a process of competitor analysis and benchmarking by using artificial intelligence (AI) technique to continuously monitor content strategies and performance of competitors creating similar textual content. The AI technique analyzes the websites of competitors to identify the strengths and weaknesses, providing insights into effective SEO strategies. Said process includes a tracking keyword usage, the backlink profiles, a content quality, and the user engagement metrics. The remote server 102 then benchmarks the website against the competitors, highlighting areas where improvements can be made to gain a competitive edge. By continuously monitoring the competitive landscape, system 100 affirms that the website remains up to date with industry trends and best practices.

In an embodiment, the remote server 102 may employ predictive analytics to guide link-building strategies by analyzing the potential value of inbound and outbound links and predicting the impact of said links on SEO performance. The predictive analytics engine evaluates various factors such as the authority, relevance, and traffic of linking sites to recommend high-value link-building opportunities. By analyzing historical data and trends, the system 100 can forecast the SEO benefits of acquiring specific backlinks. The remote server 102 also assesses the impact of outbound links from the website, making sure that they contribute positively to the overall SEO strategy.

In an embodiment, remote server 102 may generate detailed SEO reports, comprising the keyword performance, the content analysis, the backlink profiles, and the overall SEO score. The keyword performance section includes data on the keyword rankings, a search volume, and a competition, providing insights into the effectiveness of the current keyword strategy. The content analysis section evaluates the quality, relevance, and readability of the content, highlighting areas for improvement. The backlink profiles section details the quality and quantity of inbound and outbound links, offering recommendations for link-building strategies. The overall SEO score is a metric that reflects the SEO health and performance of the website. The detailed reports provide users with actionable insights and data-driven recommendations, enabling them to make informed decisions to enhance their SEO efforts. The reports are generated periodically, so that users stay updated on SEO performance and progress of their website. The remote server 102 may utilize a sentiment analysis technique to gauge user sentiment from one or more social media and other online platforms to generate sentiment data, wherein the remote server 102 further incorporates the generated sentiment data into the SEO recommendations. The sentiment analysis technique involves evaluating user comments, reviews, and mentions to understand the public perception of the website and its content. Said data provides insights into how users feel about the website, identifying areas of positive reception as well as aspects that may need improvement.

In an embodiment, system 100 enhances search engine optimization (SEO) of the website by utilizing advanced data processing and analysis capabilities. The remote server 102 comprises the memory 104, which stores a set of executable routines and a search engine database with multiple fields of application. Each field corresponds to multiple URLs, indexed with a user engagement matrix, a written data, and a search engine ranking. The structured data storage enables efficient retrieval and analysis, which enables accurate SEO optimization. The processor 106 acquires a web link from the computing device 108, initiating the process. By crawling the website (accessed through the web link) to extract textual content, the processor 106 compiles data about the current state of website. Analyzing the extracted textual content allows processor 106 to determine the relevant field of application of website, which is essential for contextual SEO improvements.

In an embodiment, evaluating the extracted textual content involves determining a thematic score, a readability score, and an emotional tone data using a natural language processing (NLP) technique. Said scores provide a multi-faceted understanding of the effectiveness of content, readability, and emotional impact, which are important factors for SEO success. The analysis extends to the written data of the acquired URLs, determining a topic weight, a legibility weight, and a sentiment tone data.

In an embodiment, developing the machine learning model using the search engine database, the determined, topic weight, legibility weight, and sentiment tone data of each URL equips the system 100 with predictive capabilities. Applying the developed machine learning model to the scores of extracted contents identifies specific content alterations required to enhance SEO.

In an embodiment, rendering the recommended content alterations at the computing device 108 provides users with actionable insights to optimize their website content. Said recommendations are based on multiple SEO factors, including keyword density, meta tags, content structure, and user engagement elements. Said approach addresses various aspects of SEO, affirming that the website content is relevant and engaging and technically optimized for search engines.

In an embodiment, remote server 102 integrates with content management systems (CMS) and SEO platforms, facilitating automated content optimization workflows. Said integration streamlines the implementation of SEO recommendations, reducing the manual effort required from users and assuring consistency across all content updates. By automating the workflows, system 100 enhances efficiency and allows users to focus on content quality and strategy.

In an embodiment, an application program interface (API) allows direct implementation of recommended content alterations into the website and optimization processes. The API makes sure that changes are applied accurately and consistently, minimizing the risk of human error. The direct implementation capability enhances the overall effectiveness of the SEO process, providing users with a seamless and reliable method to update their website content.

In an embodiment, remote server 102 automates competitor analysis and benchmarking using artificial intelligence (AI). By continuously monitoring content strategies and the performance of competitors, system 100 provides users with valuable insights into industry trends and best practices. The automation allows users to stay ahead of the competition by making informed decisions based on real-time data.

In an embodiment, remote server 102 employs predictive analytics to guide link-building strategies. By analyzing the potential value of inbound and outbound links, system 100 predicts the impact of the links on SEO performance. The predictive capability enables users to focus on high-impact link-building opportunities, optimizing their backlink profiles for maximum SEO benefit. The remote server 102 generates detailed SEO reports, including keyword performance, content analysis, backlink profiles, and an overall SEO score. Said reports provide users with an overview of SEO health of their website, highlighting areas for improvement and tracking progress over time. The detailed insights offered by said reports empower users to make data-driven decisions to enhance their SEO strategies.

In an embodiment, remote server 102 utilizes a sentiment analysis technique to gauge user sentiment from social media and other online platforms. The generated sentiment data is incorporated into the SEO recommendations, so that the content resonates with the target audience. By aligning the content with user sentiment, system 100 enhances user engagement and satisfaction, contributing to better search engine rankings and overall website performance.

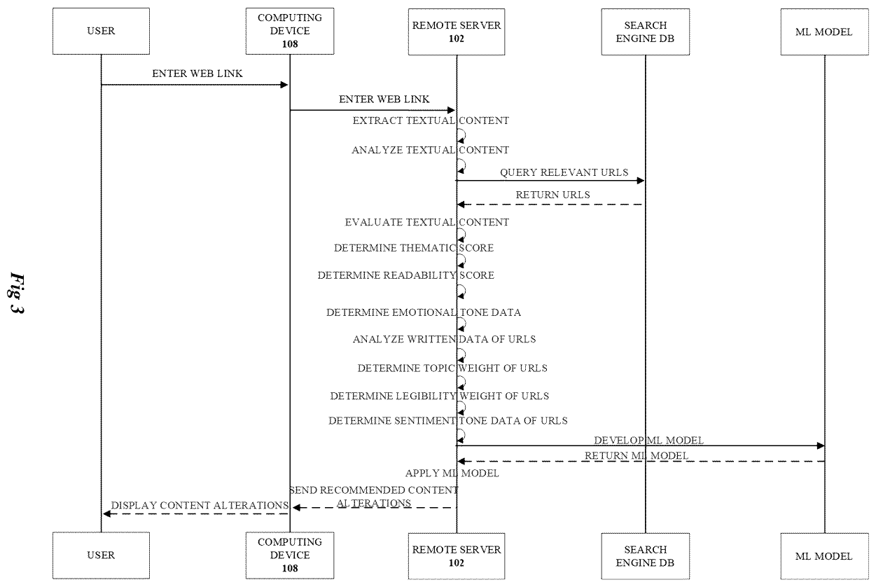

FIG. 3 illustrates a sequence diagram of system 100 to enhance search engine optimization (SEO) of a website in accordance with the embodiments of the present disclosure. A user enters a web link into a computing device 108, which sends the web link to a remote server 102. The remote server 102 extracts the textual content from the web link and analyzes said textual content to determine the relevancy of the field of application. The remote server 102 queries the search engine database for relevant URLs and retrieves said URLs. The remote server 102 evaluates the extracted textual content to determine a thematic score, a readability score, and an emotional tone data. Additionally, the remote server 102 analyzes the written data of the retrieved URLs to determine a topic weight, a legibility weight, and a sentiment tone data. A machine learning (ML) model is developed using said data (determined topic weight, determined legibility weight, and determined sentiment tone data) and the search engine database. The ML model is applied to the determined, thematic score, readability score, and emotional tone data of the extracted textual content to recommend content alterations required to enhance SEO. The remote server 102 sends the recommended content alterations to the computing device 108, which displays the content alterations to the user, facilitating the optimization of the web link's content.

Example embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including hardware, software, firmware, and a combination thereof. For example, in one embodiment, each block of the block diagrams and flowchart illustrations, and combinations of blocks in the block diagrams and flowchart illustrations can be implemented by computer program instructions. These computer program instructions may be loaded onto a general-purpose computer, special purpose computer, or other programmable data processing apparatus to produce a machine, such that the instructions which execute on the computer or other programmable data processing apparatus create means for implementing the functions specified in the flowchart block or blocks.

Operations in accordance with a variety of aspects of the disclosure is described above would not have to be performed in the precise order described. Rather, various steps can be handled in reverse order or simultaneously or not at all.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

Throughout the present disclosure, the term ‘Artificial intelligence (AI)’ as used herein relates to any mechanism or computationally intelligent system that combines knowledge, techniques, and methodologies for controlling a bot or other element within a computing environment. Furthermore, the artificial intelligence (AI) is configured to apply knowledge and that can adapt it-self and learn to do better in changing environments. Additionally, employing any computationally intelligent technique, the artificial intelligence (AI) is operable to adapt to unknown or changing environment for better performance. The artificial intelligence (AI) includes fuzzy logic engines, decision-making engines, preset targeting accuracy levels, and/or programmatically intelligent software.

What is claimed is:

1. A computer-implemented method for improving search engine optimization (SEO) of a web page, comprising:
receiving, at a remote server, a web link from a client computing device;
accessing the web link and extracting textual content from the web page;
analyzing the extracted textual content using a natural language processing (NLP) engine to generate a thematic relevance score, a readability score, and an emotional tone data;
identifying, from a search engine database stored in a memory of the remote server, a set of reference web pages associated with a relevant content category, wherein each reference web page is indexed with written data, a user engagement score, and a historical search engine ranking;
applying the NLP engine to the written data of each reference web page to compute a topic weight, a legibility weight, and a sentiment tone data;
training a machine learning model using the computed topic weights, legibility weight, sentiment tone data, and historical ranking data of the reference web pages to generate optimization parameters;
inputting the thematic relevance score, readability metric, and emotional tone value of the extracted textual content into the trained machine learning model to generate content alteration recommendations; and
transmitting the content alteration recommendations to the client computing device for display.

2. The method of claim 1, wherein the recommended content alterations are based on a plurality of SEO factors selected from the group consisting of: keyword density, meta tags, content structure, and user engagement elements.

3. The method of claim 1, wherein said server is configured to enable integration with a content management system (CMS) and the SEO platforms to facilitate the automated content optimization workflows.

4. The method of claim 3, wherein an application program interface (API) is utilized to allow the user to implement the recommended content alterations into the textual content of the web link and the optimization processes.

5. The method of claim 1, wherein said server is further configured to automate a process of competitor analysis and benchmarking by using an artificial intelligence (AI) technique to continuously monitor the content strategies.

6. The method of claim 1, wherein the server is configured to generate the detailed SEO reports comprising a keyword performance, a content analysis, the backlink profiles, and an overall SEO score.

7. The method of claim 1, wherein the server is further configured to utilize a sentiment analysis technique to gauge user sentiment from one or more social media and other online platforms to generate the mood data, wherein the server further incorporates the generated mood data into the SEO recommendations.

8. A search engine optimization (SEO) system, comprising:
a remote server comprising:
a memory comprising a set of executable routines and a search engine database comprising the multiple fields of applications, wherein each field of application is associated with the multiple uniform resource locators (URLs), wherein each URL is indexed, individually, with, a user engagement matrix, a written data and a search engine ranking; and
a processor configured to:
acquire a web link from a computing device;
access the acquired web link to extract a textual content;
analyze the extracted textual content to determine a relevancy of the field of application;
acquire each URL from the search engine database based on the determined relevant field of application;
evaluate the extracted textual content to determine a thematic score, a readability score, and an emotional tone data of the extracted textual content by applying a natural language processing (NLP) technique;
analyze the written data associated with each of the acquired URL to determine a topic weight, a legibility weight and a sentiment tone data by applying the NLP technique;
develop a machine learning model by utilizing the search engine database, the determined topic weight, the determined legibility weight and the determined sentiment tone data, of each URL;
apply, the developed machine learning model at the determined thematic score, the determined readability score, and the determined emotional tone data of the extracted textual content, to recommend the content alterations required to enhance search engine optimization of the web link; and
render the recommended content alterations, at the computing device.

9. The system of claim 8, wherein the recommended content alterations are based on the multiple SEO factors which are selected from a keyword density, the meta tags, a content structure, and the user engagement elements.

10. The system of claim 8, wherein said server is configured to enable integration with a content management system (CMS) and the SEO platforms to facilitate the automated content optimization workflows.

11. The system of claim 10, wherein an application program interface (API) is utilized to allow the user to implement the recommended content alterations into the textual content of the web link and the optimization processes.

12. The system of claim 8, wherein said server is further configured to automate a process of competitor analysis and benchmarking by using an artificial intelligence (AI) technique to continuously monitor the content strategies.

13. The system of claim 8, wherein the server is configured to generate the detailed SEO reports comprising a keyword performance, a content analysis, the backlink profiles, and an overall SEO score.

14. The system of claim 8, wherein the server is further configured to utilize a sentiment analysis technique to gauge user sentiment from one or more social media and other online platforms to generate the mood data, wherein the server further incorporates the generated mood data into the SEO recommendations.
